(19) United States
(12) Patent Application Publication
(10) Pub. No.: US 2015/0073576 A1
(43) Pub. Date: Mar. 12, 2015

(54) CONSTRUCTION PROCESS MANAGEMENT SYSTEM AND CONSTRUCTION PROCESS MANAGEMENT METHOD

(71) Applicant: Kabushiki Kaisha Toshiba, Minato-ku, Tokyo (JP)

(72) Inventor: Hiroyuki Ushijima, Kawasaki (JP)

(73) Assignee: Kabushiki Kaisha Toshiba, Minato-ku, Tokyo (JP)

(21) Appl. No.: 14/385,848

(22) PCT Filed: Mar. 18, 2013
(86) PCT No.: PCT/JP13/57691

§ 371 Date: Sep. 17, 2014

(30) Foreign Application Priority Data
Mar. 19, 2012 (JP) 2012-062589

(51) Int. Cl. G05B 19/418; G06F 17/50

(52) U.S. Cl. CPC G05B 19/41875; G06F 17/50; G05B 2219/24015
USPC 700/98; 700/108

(57) ABSTRACT

A construction process management system includes storage units that store work information of work to be carried out during construction of a plant, and section information, period information, and system information associated with the work information. The section information indicates a section in which work is performed among plural sections in the plant. The period information indicates a period in which the work is performed. The system information indicates a system to which the work belongs among systems in the construction work. The construction process management system further includes a process chart generation unit that extracts work information for section information item and generates a section-based process chart showing a process of work for each section based on the period information, and a conversion unit that converts the section-based process chart into a system-based process chart showing the process of work for each system based on the system information.

### TECHNICAL FIELD

The present invention relates to a plant construction process management system and a plant construction management method that manages the construction process of a plant by section and by system thereof.

### BACKGROUND ART

When carrying our work to construct a nuclear power plant or a thermal power plant out, a process chart is created and process management is performed on the basis of the process chart. Nowadays, the development of tools that electronically simulate the circumstances of construction work using a three-dimensional computer-aided design (CAD) system and a process management system is proceeding. Such tools enhance the accuracy of work design drawings and make it possible to visualize the state of progression.

For example, Patent Document 1 discloses technology that visualizes transitions in the installation of equipment modules and members in accordance with a process chart by performing moving-image simulation using the shapes of the equipment modules and members.

### RELATED ART DOCUMENTS

### Patent Document

### Patent Document 1

Japanese Patent Laid-Open No. 2001-262829

### SUMMARY OF THE INVENTION

### Problems to be Solved by the Invention

At the initial stage of work to construct a plant, section-based construction work management is performed by. Section-based construction work management is a method that manages construction work in small room units that are selected based on a laying route, a work sequence and a work amount of construction work that are related to equipment as represented by plumbing, electrical instrumentation or air conditioning equipment.

When the construction work progressiones and the power supply board begins to receive electricity, the construction work is thereafter managed with respect to each function and system of the plant facilities (in-service of the equipment in the plant). And then, it becomes possible to manage the system-based construction work. System-based construction work management is a method that manages the state of the progression of construction work of each section or for item of equipment associated with a system by function (by system).

As described above, in the initial stage of construction work, section-based construction work management is adopted, and a section-based process chart is used. Therefore, as the construction work progressiones it is necessary to separately create a system-based process chart in order to manage the construction work from the two viewpoints of section-based management and system-based management.

However, in the case of creating a system-based process chart at an intermediate stage or latter stage of construction work, it is needed to create or alter the system-based process chart based on a section-based process chart. This work requires a great deal of time and effort, and complicates the management.

Further, the time that the power supply board begins to receive electricity is in the latter stage of the plant construction work. Since there is a tendency for the number of construction work items and the number of man hours accompanying such construction work to increase in processes performed in the later stage, the time for creating and the volume of section-based and system-based process charts as well as the time required to create the process charts increase.

The present invention has been conceived in consideration of the above described circumstances, and an object of the present invention is to provide a construction process management system and a construction process management method that can unify section-based construction work management and system-based construction work management and reduce the time required for process chart creation.

### Means for Solving the Problem

To solve the above described problems, a construction process management system according to the present invention comprises: a storage unit that stores work information relating to work that is carried out during construction work of a plant, as well as section information, period information, and system information that are associated with the work information, of which the section information relates to a section in which the work is carried out among a plurality of sections that are defined in the plant, the period information relates to a period for carrying out the work and the system information relates to a system to which the work belongs among systems that are under the executing of the construction work; a process chart generation unit that extracts the work information for each of the section information items, and generates a section-based process chart that shows a process of the work for each of the sections based on the period information of the work information that is extracted; and a conversion unit that converts the section-based process chart to a system-based process chart that shows a process of the work for each of the systems based on the system information.

### Advantages of the Invention

According to the construction process management system and the construction process management method according to the present invention, section-based construction work management and system-based construction work management can be unified and a time period required for process chart creation can be reduced.

### BRIEF DESCRIPTION OF THE DRAWINGS

FIG. 1 is a functional block diagram illustrating one embodiment of a construction process management system according to the present invention.

FIG. 2 is an explanatory drawing that illustrates an example of process data that is stored in a process data storage unit and CAD data that is stored in a CAD data storage unit.

FIG. 3 is an explanatory drawing that illustrates an example of a section-based process chart.

FIG. 4 is an explanatory drawing that conceptually illustrates a simulation moving image.

FIG. 5 is an explanatory drawing that illustrates a section-based process chart of selected sections.

FIG. 6 is an explanatory drawing that conceptually illustrates a simulation moving image relating to a section B and a section C.

FIG. 7 is a flowchart that illustrates process chart conversion processing that is executed by the construction process management system according to the embodiment.

FIG. 8 is an explanatory drawing that illustrates an example of a system-based process chart relating to a system A.

FIG. 9 is an explanatory drawing that conceptually illustrates a simulation moving image relating to the system A.

FIG. 10 is a flowchart that illustrates process editing processing that is executed by the construction process management system according to the embodiment.

FIG. 11 is an explanatory drawing that illustrates a section-based process chart before editing, in a case of editing a work period of a section-based process chart.

FIG. 12 is an explanatory drawing that illustrates the section-based process chart after editing, in the case of editing a work period of a section-based process chart.

FIG. 13 is an explanatory drawing that illustrates an example of a system-based process chart that is generated based on the section-based process chart after editing.

### DESCRIPTION OF EMBODIMENTS

One embodiment of the construction process management system and the construction process management method according to the present invention will be described with reference to the accompanying drawings. The construction process management system and the management method thereof according to the present embodiment can be applied to management of processes when constructing various kinds of plants such as, for example, a nuclear power plant or a thermal power plant.

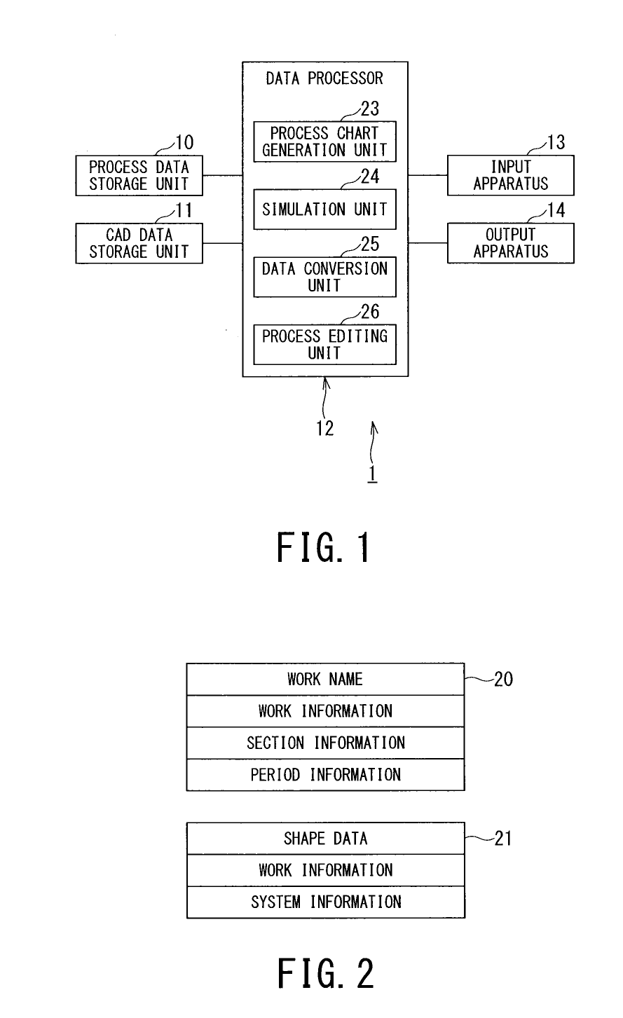

FIG. 1 is a functional block diagram illustrating one embodiment of the construction process management system according to the present invention. FIG. 2 is an explanatory drawing illustrating an example of process data 20 that is stored in a process data storage unit 10 and CAD data 21 that is stored in a CAD data storage unit 11.

The construction process management system 1 includes a process data storage unit 10, a three-dimensional CAD data storage unit (CAD data storage unit) 11, a data processor 12, an input apparatus 13, and an output apparatus 14.

The process data storage unit 10 stores data (process data 20) that is used by the process management system that manages work processes of construction work. As shown in FIG. 2, the process data storage unit 10 stores a work name, work information, section information and period information that are associated with each other. The work name is, for example, a name that is assigned for distinguishing the work in a process chart. The work information is information that is uniquely assigned to a plurality of work items to be carried out during the plant construction work. The section information is information relating to sections in which the work is carried out among a plurality of sections defined within the plant. The sections are defined in respective small room units that are selected based on a laying route, a work sequence, and a work amount of construction work that are related to equipment as represented by plumbing, electrical instrumentation or air conditioning equipment. The period information is information relating to a period within which the work is to be performed (a starting date and time and an ending date and time).

The three-dimensional CAD data storage unit (CAD data storage unit) 11 stores data (CAD data 21) that is used by a three-dimensional CAD system (3D CAD) that creates design drawings of plant facilities. As shown in FIG. 2, the CAD data storage unit 11 stores shape data, work information and system information that are associated with each other. The shape data is data that shows the shapes of members that are used in work relating to plumbing, electrical instrumentation, air conditioning equipment and other equipment (referred to simply as “work”). The CAD data storage unit 11 stores the shape data and work information regarding work in which the members shown by the shape data are used, in association with each other. The work performed during the construction work belongs to one of the systems, and the respective systems are constituted by one or a plurality of members (shape data). The system information is information relating to the system to which the shape data belongs among the systems of the plant. In other words, the system information is a value that is associated with shape data of members that comprise the system to which the work belongs.

A storage unit built in an existing process management system or a 3D CAD system may be utilized for the process data storage unit 10 and the CAD data storage unit 11. In this case, the construction process management system 1 acquires the data stored in the respective storage units 10 and 11 through a network. Further, the process data storage unit 10 and the CAD data storage unit 11 may be inherently built in the construction process management system 1. In this case, it is not necessary for the CAD data storage unit 11 and the process data storage unit 10 to be separated; these can be in a common storage unit.

The data processor 12 includes a process chart generation unit 23, a simulation unit 24, a data conversion unit 25 and a process editing unit 26.

The process chart generation unit 23 generates a section-based process chart based on process data that is stored in the process data storage unit 10. The term “section-based process chart” refers to a process chart which shows work processes in a state in which the work processes are divided according to respective sections. In the section-based process chart, for example, sections are allocated to the ordinate axis and time is allocated to the abscissa axis, and a (length of a) period in which the respective items of work are to be carried out is shown by a (length of a) process bar.

The simulation unit 24 simulates the state of construction work in accordance with a section-based process chart or a system-based process chart based on data that is stored in the CAD data storage unit 11. That is, the simulation unit 24 uses shape data to schematically visualize (create design drawings of) the state of the progression of work in accordance with each process chart. In the present embodiment, since the shape data is three-dimensional data, the state of the progression of work is simulated three-dimensionally.

The data conversion unit 25 converts a section-based process chart that was generated by the process chart generation unit 23 to a system-based process chart. The term “system-based process chart” refers to a process chart which shows work processes in a state in which the work processes are divided according to respective systems. In the system-based process chart, for example, system names are allocated to the ordinate axis and time is allocated to the abscissa axis, and the length of a period in which the respective items of work are to be carried out is shown by a process bar. The data conversion unit 25 converts the section-based process chart based on system information that is associated with the work information. Processing that is performed by the data conversion unit 25 is described in detail later.

The process editing unit 26 alters period information of work in each process chart based on an input that is accepted through the input apparatus 13. Processing that is performed by the process editing unit 26 is described in detail later.

The input apparatus 13 is an apparatus such as a keyboard or a mouse, and is an apparatus for allowing the data processor 12 to accept an instruction from an operator. The output apparatus 14 is an apparatus such as a display or a printer, and is an apparatus for presenting a processing result obtained by the data processor 12 to an operator.

Next, the actions of the construction process management system 1 in the present embodiment will be described.

First, a section-based process chart that is generated by the process chart generation unit 23 and a simulation moving image that is generated by the simulation unit 24 will be described.

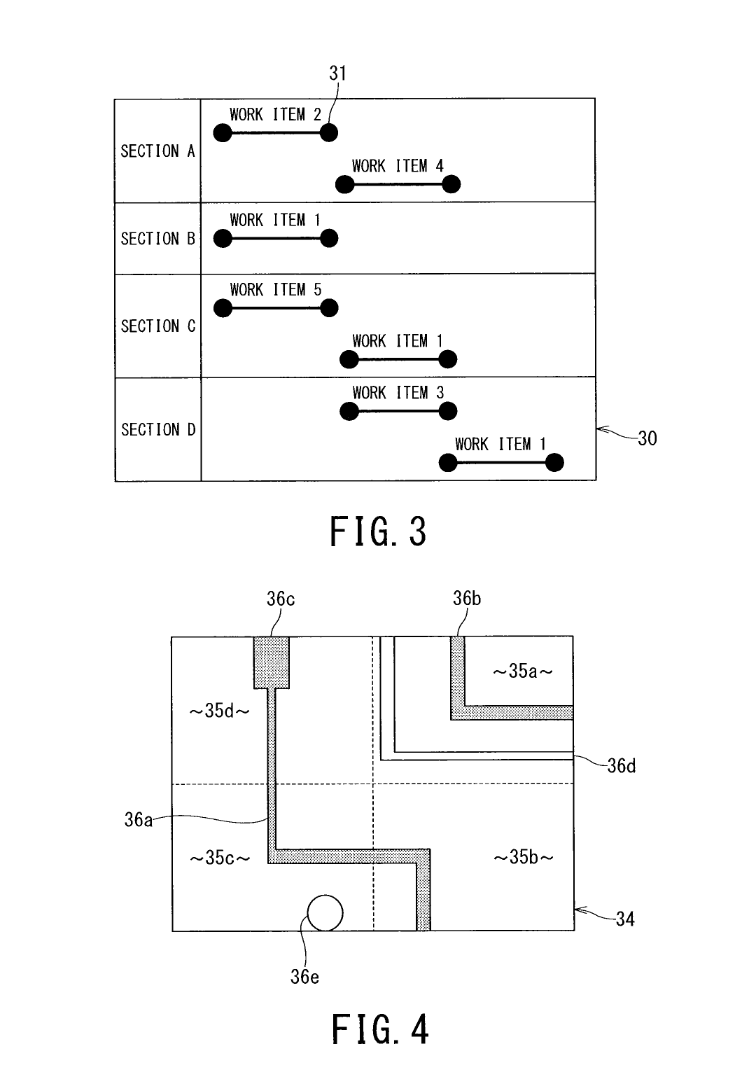

FIG. 3 is an explanatory drawing that illustrates an example of a section-based process chart 30. FIG. 4 is an explanatory drawing that conceptually illustrates a simulation moving image 34. For convenience in the description, the simulation moving image 34 is illustrated with a plan view.

As shown in FIG. 3, in the section-based process chart 30, sections are allocated to the ordinate axis and time is allocated to the abscissa axis, and a bar (hereunder, referred to as “process bar”) 31 is used to show a period in which the respective items of work are to be carried out. A work name that is recognizable by the operator is displayed on each process bar 31. In FIG. 3, the work names are “work item 1” to “work item 5”.

As shown in FIG. 4, in the simulation moving image 34, shape data included in section A 35a to section D 35d is displayed three-dimensionally. Boundaries between the respective sections from section A 35a to section D 35d are shown with dashed lines. Further, shape data A 36a to shape data E 36e is used as the shape data in section A 35a to section D 35d.

Members relating to shape data A 36a to shape data C 36c are members comprising system A as one system in the plant, and system A is associated with the shape data A 36a to shape data C 36c. Further, members relating to shape data D 36d and shape data E 36e are members comprising system B, and system B is associated with the shape data D 36d and shape data E 36e.

The shape data A 36a is a member that is arranged so as to extend from section B 35b to section D 35d. The shape data B 36b is a member that is arranged in section A 35a. The shape data C 36c is a member that is arranged in section D 35d. The shape data D 36d is a member that is arranged in section A 35a. The shape data E 36e is a member that is arranged in section C 35c.

The simulation unit 24 simulates the state of construction work according to a process in the section-based process chart 30 in FIG. 3. For example, if the process bar 31 in the section-based process chart 30 is selected by an operator, the simulation unit 24 simulates the state of work based on the process data 20 and the CAD data 21 relating to the process bar 31. For example, based on the period information stored in the process data storage unit 10, the simulation unit 24 displays only members (shape data) relating to construction work that has already been completed, and does not display members relating to construction work with respect to which work has not yet been performed. The operator can visually figure out the state of the construction work. The simulation unit 24 may also simulate the state of work in accordance with information such as a section and a date and time that is inputted by an operator.

In the present embodiment, it is sufficient that the simulation moving image 34 is generated in association with the section-based process chart 30, and so the display method and generation method are not limited to those described above, and known technology can be applied. In addition, the simulation unit 24 may generate a still image at a certain time as the simulation result, and not only a moving image.

The construction process management system 1 can also generate the section-based process chart 30 and the simulation moving image 34 of only sections selected by the operator.

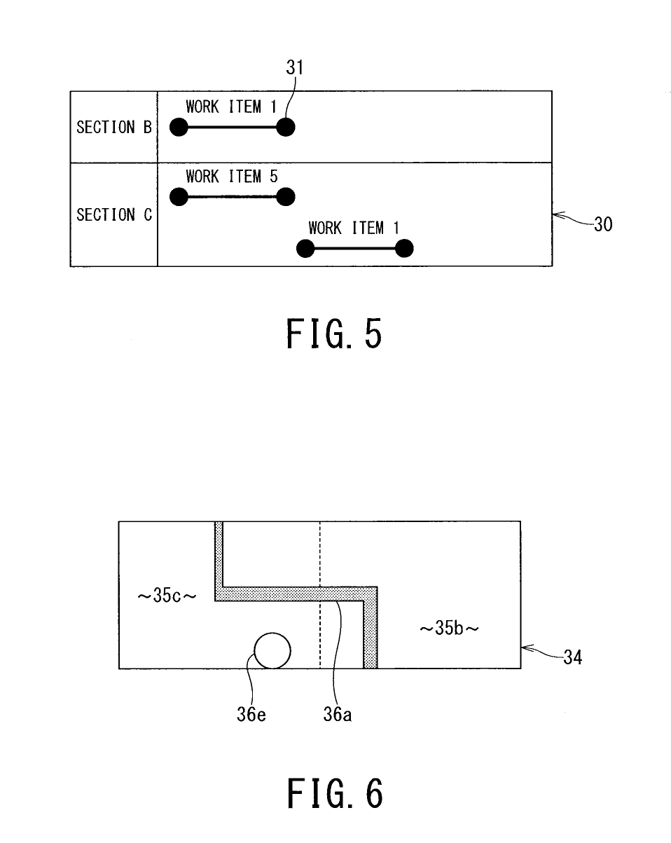

FIG. 5 is an explanatory drawing illustrating the section-based process chart 30 for selected sections. The process chart generation unit 23 accepts the input of a section name of a section for which to display the section-based process chart 30, that the operator inputs through the input apparatus 13. At this time, the input apparatus 13 accepts input of one or a plurality of sections. In a case where “section B 35b” and “section C 35c” are selected, the process chart generation unit 23 refers to the process data storage unit 10 and reads out the process data 20 having the section information relating to “section B 35b” and “section C 35c” that were inputted.

The simulation unit 24 generates the simulation moving image 34 that relates to the inputted sections, and outputs the generated simulation moving image 34 by means of the output apparatus 14. FIG. 6 is an explanatory drawing that conceptually shows the simulation moving image 34 relating to section B 35b and section C 35c. In the simulation moving image 34 shown in FIG. 6, the state of construction work in section B 35b and section C 35c is simulated. The simulation unit 24, for example, displays only shape data A 36a and shape data E 36e that are included in section B 35b and section C 35c, and does not display the shape data for section A 35a and section D 35d.

The output apparatus 14 outputs the section-based process chart 30 and the simulation moving image 34 that are generated. The operator can easily obtain the section-based process chart 30 relating to a desired section, and can review the construction plan while confirming the relation between a plurality of sections based on the detailed schedule plan for one section.

Next, processing when converting the section-based process chart 30 and the simulation moving image 34 to a system-based process chart and a simulation moving image are described.

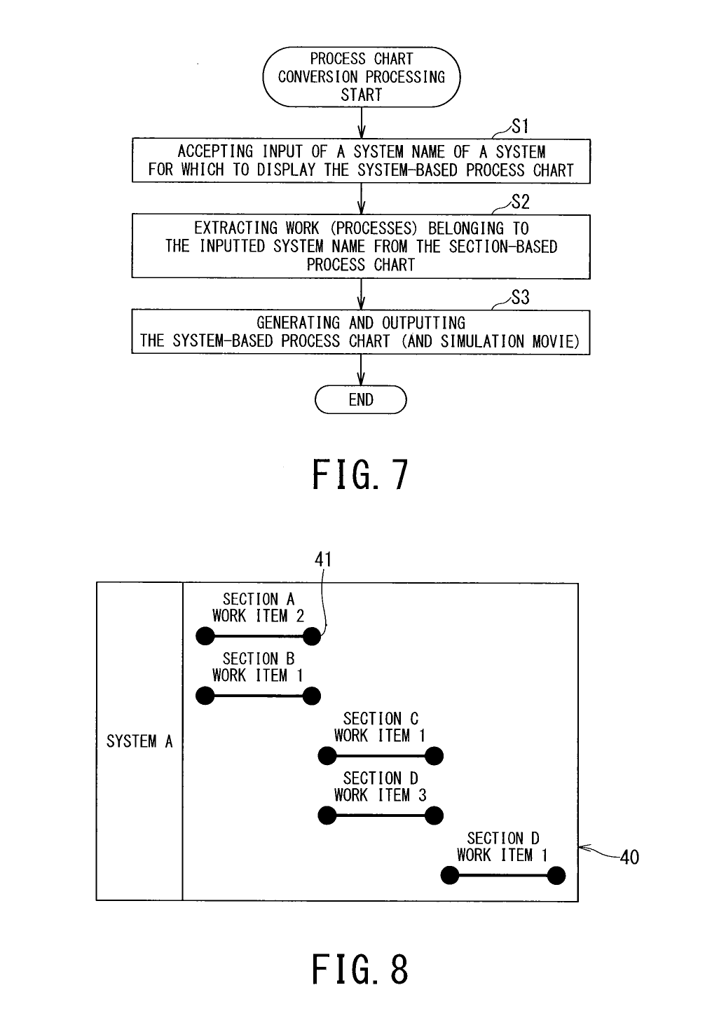

FIG. 7 is a flowchart that illustrates process chart conversion processing that is executed by the construction process management system 1 according to the present embodiment.

In step S1, the input apparatus 13 accepts input by the operator of a system name of a system for which to display the system-based process chart 40 and the simulation moving image 34. At this time, the input apparatus 13 accepts input of one or a plurality of systems. The input apparatus 13, for example, accepts input of “system A”. The input apparatus 13 supplies the inputted system name to the data processor 12.

In step S2, the data conversion unit 25 of the data processor 12 extracts work (processes) belonging to the inputted system name from the section-based process chart 30. That is, the data conversion unit 25 refers to the work information of each process shown in the section-based process chart 30, and extracts work having work information which system information relating to the inputted system name is associated with. For example, the data conversion unit 25 extracts only work relating to system A from the section-based process chart 30 shown in FIG. 3. Further, in a case where a plurality of system names were inputted in the inputting step S1, the data conversion unit 25 extracts work for each item of system information.

In step S3, the data conversion unit 25 rearranges the processes extracted in the extracting step S2 for each of the inputted systems, and generates the system-based process chart 40 relating to the inputted systems.

FIG. 8 is an explanatory drawing showing an example of the system-based process chart 40 relating to system A. In the system-based process chart 40, a system name is allocated to the ordinate axis and time is allocated to the abscissa axis, and periods in which respective work items are to be carried out are shown using process bars 41. That is, the system-based process chart 40 shown in FIG. 8 corresponds to a chart for which only work associated with system A is extracted from the section-based process chart 30 in FIG. 3, and the extracted work has been rearranged and displayed. Further, in a case where a plurality of system names were inputted in the inputting step S1, the data conversion unit 25 converts the section-based process chart to the system-based process chart 40 by rearranging the extracted processes for each system. Together with the process bar 41, the data conversion unit 25 also displays the section name to which the process of each work item belongs.

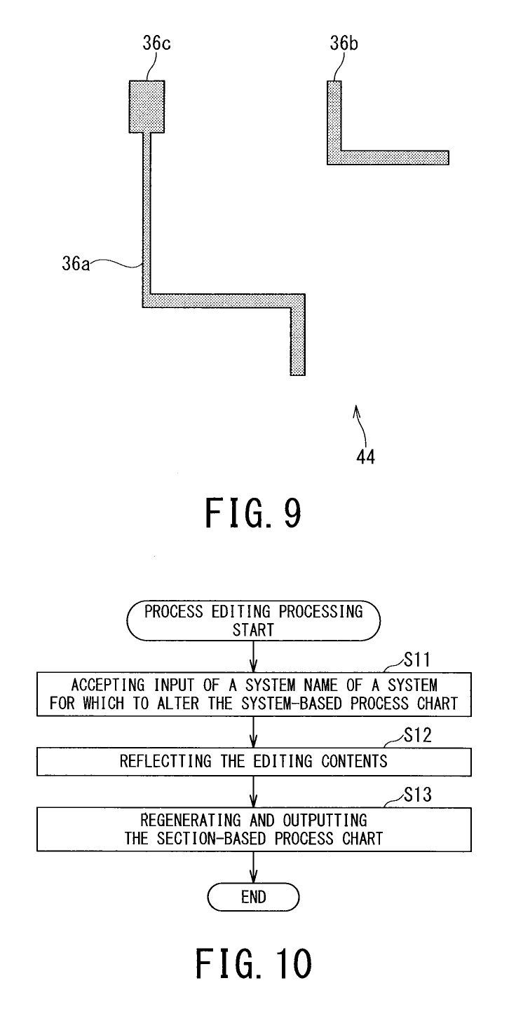

The simulation unit 24 generates a simulation moving image that relates to the system that was inputted. The simulation unit 24 refers to the CAD data storage unit 11, and reads out shape data having system information that relates to the inputted system name. FIG. 9 is an explanatory drawing that conceptually shows the simulation moving image 44 relating to system A. For example, the simulation unit 24 simulates the state of construction work of the shape data A 36a to shape data C 36c that are associated with “system A”.

The output apparatus 14 outputs the system-based process chart 40 and the simulation moving image 44 that were generated.

According to the construction process management system 1 that executes the above described process chart conversion processing, the section-based process chart 30 and the system-based process chart 40 can be easily generated in accordance with the stage of the construction work. More specifically, at the initial stage of construction work, the construction process management system 1 can provide the section-based process chart 30 that corresponds to management units of the construction work. On the other hand, when the construction work progressiones and the management units of the construction work have changed to system-based units, the construction process management system 1 can provide the system-based process chart 40 that is electronically generated on a computer based on the section-based process chart 30. That is, the construction process management system 1 can automatically convert the section-based process chart 30 to the system-based process chart 40, and can thereby reduce the time and costs that are required to create a new system-based process chart 40.

Further, the construction process management system 1 can output the simulation moving images 34 and 44 that correspond to the section-based process chart 30 and the system-based process chart 40 together with those process charts. Thus, the construction process management system 1 can make the state of the construction work visually recognizable.

Further, the construction process management system 1 can convert one kind or more among a process chart and a simulation moving image between a section-based format and a system-based format, and can make the process of construction work visually recognizable from two viewpoints. Thus, the construction process management system 1 can decrease the occurrence of erroneous recognition of work and also the occurrence of needless work that is based on such erroneous recognition, and as a result can reduce the time required to review work.

By converting the section-based process chart 30 (and simulation moving image 34) to the system-based process chart 40 (and simulation moving image 44) using the construction process management system 1, the operator can visually recognize whether all construction work and electrical and instrumentation testing has been completed before starting to test the systems of the plant. Further, in a case where construction work is not completed, the operator can obtain an image by means of 3D CAD (simulation moving image) of the contents of the remaining construction work and also confirm the existence of interfering objects that will constitute a problem, and thus a review time period in the construction plan can be reduced.

The information comprising the display of the section-based process chart 30 and the system-based process chart 40 is the same, and only the display methods are different. Consequently, the construction process management system 1 can reduce the occurrence of input errors that arise when performing work to separately create the system-based process chart 40.

Next, processing for editing a work period through the section-based process chart 30 that is executed by the process editing unit 26 will be described.

FIG. 10 is a flowchart that illustrates process editing processing that is executed by the construction process management system 1 according to the present embodiment.

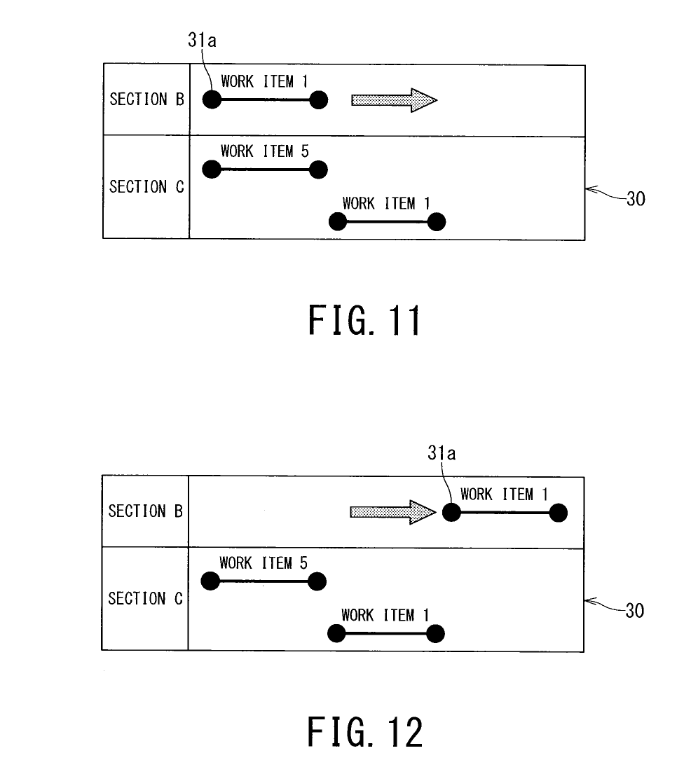

FIG. 11 is an explanatory drawing that illustrates the section-based process chart 30 before editing, in the case of editing a work period of the section-based process chart 30. FIG. 12 is an explanatory drawing that illustrates the section-based process chart 30 after editing, in the case of editing a work period of the section-based process chart 30.

In FIG. 11 and FIG. 12, the process editing processing is described using the section-based process chart 30 of section B 35b and section C 35c as one example.

In step S11, the input apparatus 13 accepts contents for editing a work period that are input by an operator by moving the process bar 31 of a work period (period information) that the operator wants to alter. For example, as shown in FIG. 11, the operator moves a process bar 31a of section B 35b to which work item 1 has been allocated to the right using the input apparatus 13 such as a mouse, to thereby delay the work period relative to the initial period (delay the starting date and time and the ending date and time). The input apparatus 13 supplies the inputted editing contents to the data processor 12.

In step S12, the process editing unit 26 of the data processor 12 reflects the editing contents in the process data storage unit 10. That is, the process editing unit 26 edits the process data 20 relating to the work item 1 in accordance with the contents of the input operation. Note that a configuration may also be adopted in which the process editing unit 26 provides a storage region in the data processor 12 and stores the relevant alteration in the storage region, and does not alter the process data 20 in the process data storage unit 10.

In step S13, the process editing unit 26 regenerates the section-based process chart 30 in which the inputted editing contents are reflected. Further, the simulation unit 24 also regenerates the simulation moving image 34 in accordance with the alterations in the section-based process chart 30. Because the period in which the construction work is carried out is delayed, the display timing of members relating to the altered work is also delayed. That is, the timing at which the members (shape data) relating to work item 1 of section B 35b are displayed is delayed. The output apparatus 14 outputs the section-based process chart 30 and the simulation moving image 34 that were generated.

Thereafter, for example, upon accepting an instruction from the operator to convert the section-based process chart 30 to the system-based process chart 40, similarly to the extracting step S2 and generating and outputting step S3 in FIG. 7 described above, the data conversion unit 25 generates the system-based process chart 40 based on the section-based process chart 30 after editing.

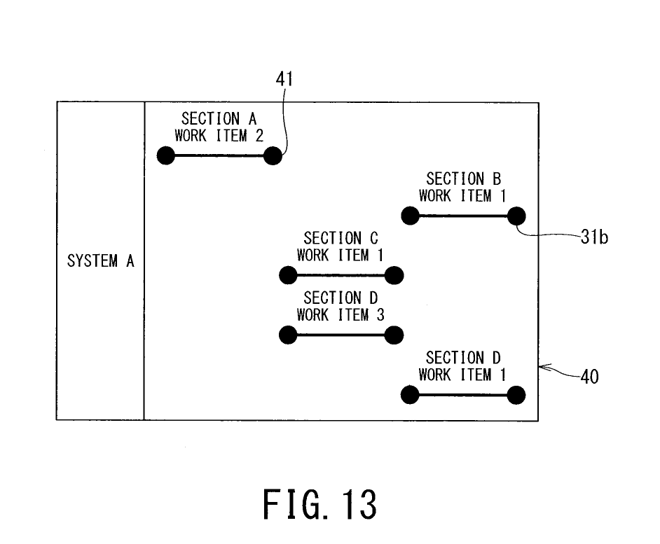

FIG. 13 is an explanatory drawing illustrating an example of the system-based process chart 40 that is generated based on the section-based process chart 30 after editing.

In the system-based process chart 40 in FIG. 13, the display position of the process bar 31b corresponding to the work item 1 of section B 35b that was altered in the section-based process chart 30 has moved to the right side in comparison to the system-based process chart 40 shown in FIG. 8. That is, the period in which the process is carried out is automatically altered and displayed. Further, the simulation unit 24 delays the timing at which the members relating to the work item 1 of section B 35b are displayed in the simulation moving image 44 relative to the timing before the alteration.

Thus, according to the construction process management system 1, a work period that was altered in the section-based process chart 30 can be automatically reflected in the system-based process chart 40. That is, even in a case where the period of a work process was altered, the construction process management system 1 can reduce the work of an operator to individually reflect the alteration in the system-based process chart 40.

Further, according to the construction process management system 1, in the case of constructing a plant having design specifications that are similar to design specifications to be used thereafter, section-based process charts 30 that were already generated can be easily edited and used, and creation time periods and creation costs relating to the section-based process charts 30 and system-based process charts 40 can be reduced.

In addition, according to the construction process management system 1, since alterations to the section-based process chart 30 and the system-based process chart 40 can be converted into electronic information, by notifying alterations and revisions in the section-based process chart 30 to the manager of the system-based process chart 40, a creation time period and creation costs with respect to a revised version of the system-based process chart 40 that accompany work to alter the system-based process chart 40 can be reduced.

Further, the information comprising the display of the section-based process chart 30 and the system-based process chart 40 is the same, and only the display methods are different. Consequently, the construction process management system 1 can reduce the occurrence of input errors that arise when performing work to separately alter the system-based process chart 40 after altering and revising the section-based process chart 30.

That is, the construction process management system 1 and the management method thereof according to the present embodiment can unify section-based construction work management and system-based construction work management and reduce the time required to create process charts.

Although several embodiments of the present invention have been described above, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the gist of the inventions. These embodiments and the modifications thereof are included within the scope and gist of the invention, and are also included in the scope of the inventions described in the accompanying claims and their equivalents.

The technique described in the present embodiment can be written on, for example, a storage medium such as a magnetic disc, an optical disc, or a semiconductor memory as a program that a computer can be caused to execute, and applied to various apparatuses, and can also be transmitted by means of a communication medium and applied to various apparatuses. A computer that realizes the present apparatus executes the above described processing by reading the program that was recorded on the storage medium, and having the operations thereof controlled by the program.

### REFERENCE SIGNS LIST

1 construction process management system
10 process data storage unit
11 three-dimensional CAD data storage unit (CAD data storage unit)
12 data processor
13 input apparatus
14 output apparatus
20 process data
21 CAD data
23 process chart generation unit
24 simulation unit
25 data conversion unit
26 process editing unit
30 section-based process chart
31, 41 process bar
34, 44 simulation moving image
40 system-based process chart

1. A construction process management system, comprising:
a storage unit that stores work information relating to work that is carried out during construction work of a plant, as well as section information, period information, and system information that are associated with the work information, of which the section information relates to a section in which the work is carried out among a plurality of sections that are defined in the plant, the period information relates to a period in which the work is carried out, and the system information relates to a system to which the work belongs among systems included in the construction work;
a process chart generation unit that extracts the work information for each of the section information items, and generates a section-based process chart that shows a process of the work for each of the sections based on the period information of the work information that is extracted; and
a conversion unit that converts the section-based process chart to a system-based process chart that shows a process of the work for each of the systems based on the system information.

2. The construction process management system according to claim 1, wherein:
the storage unit further stores shape data of a member that is used in the construction work that is associated with the work information; and
the system information is a value that is associated with the shape data of the member comprising a system to which the work belongs;
the construction process management system further comprising a simulation unit that simulates a state of construction work by section in accordance with the section-based process chart using the shape data of the member relating to the work that is included in the section-based process chart, or simulates a state of construction work by system in accordance with the system-based process chart using the shape data of a member relating to the work that is included in the system-based process chart.

3. The construction process management system according to claim 1, wherein the conversion unit converts the section-based process chart to the system-based process chart by extracting the work for each item of system information and rearranging the extracted work for each of the systems, based on the system information that is associated with the work information of the work included in the section-based process chart.

4. The construction process management system according to claim 1, further comprising an input unit that accepts selection of one or a plurality of sections among sections included in the section-based process chart,
wherein the process chart generation unit generates a section-based process chart of the section that is selected.

5. The construction process management system according to claim 1, further comprising:
a display unit that displays the section-based process chart or the system-based process chart in which a period in which the work is carried out is shown as a bar based on the period information;
an input unit that accepts an alteration of the period information that is performed by moving the bar; and
an editing unit that, in a case where the input unit accepts an alteration of the period information, edits the period information of the storage unit.

6. A construction process management method, comprising:
a step of preparing a storage unit that stores work information relating to work that is carried out during construction work of a plant, as well as section information, period information, and system information that are associated with the work information, of which the section information relates to a section in which the work is carried out among a plurality of sections that are defined in the plant, the period information relates to a period in which the work is carried out, and the system information relates to a system to which the work belongs among systems included in the construction work, and a data processor;
a process chart generation step in which the data processor extracts the work information for each of the section information items, and generates a section-based process chart that shows a process of the work for each of the sections based on the period information of the work information that is extracted; and
a conversion step in which the data processor converts the section-based process chart to a system-based process chart that shows a process of the work for each of the systems based on the system information.
